(19) United States
(12) Patent Application Publication
(10) Pub. No.: US 2018/0292556 A1
(43) Pub. Date: Oct. 11, 2018

(54) SYSTEMS AND METHODS FOR DEGHOSTING SEISMIC DATA USING MIGRATION OF SPARSE ARRAYS

(71) Applicant: CGG SERVICES SAS, Massy (FR)

(72) Inventors: Julien COTTON, Paris (FR); Cecile BERRON, Massy (FR); Benoit DE CACQUERAY, Clamart (FR); Florian DURET, Montigny le Bretonneux (FR); Eric FORGUES, Bures-sur-Yvette (FR)

(21) Appl. No.: 15/518,260

(22) PCT Filed: Oct. 22, 2015
(86) PCT No.: PCT/IB2015/002049

§ 371 Date: Apr. 11, 2017

Related U.S. Application Data
(60) Provisional application No. 62/067,529, filed on Oct. 23, 2014.

(51) Int. Cl. G01V 1/36

(52) U.S. Cl. CPC G01V 1/362; G01V 2210/56; G01V 2210/51; G01V 2210/169

(57) ABSTRACT

Systems and methods for deghosting seismic data using migration of sparse arrays are disclosed. The methods may include obtaining input seismic data, the input seismic data including a first set of seismic data recorded by a first set of seismic receivers located at a first depth, and a second set of seismic data recorded by a second set of seismic receivers located at a second depth. The method may further include migrating the first set of seismic data to an image grid, and migrating the second set of seismic data to the image grid. Additionally, the method may further include calculating a ghost wave based on the first and second sets of migrated seismic data, and deghosting the first set of migrated seismic data by removing the ghost wave.

### CROSS-REFERENCE TO RELATED APPLICATION

This application claims the benefit under 35 U.S.C. § 119 of U.S. Provisional Application Ser. 62/067,529, filed on Oct. 23, 2014, which is incorporated by reference in its entirety for all purposes.

### TECHNICAL FIELD

The present disclosure relates generally to seismic imaging and, more particularly, to systems and methods for deghosting seismic data using sparse arrays.

### BACKGROUND

Seismic exploration, whether on land or at sea, is a method of detecting geologic structures below the surface of the earth by analyzing seismic energy that has interacted with the geologic structures. A seismic energy source, referred to herein as a “seismic source” or “source,” generates a seismic signal in the form of a wave that propagates into the earth, where the seismic signal may be partially reflected, refracted, diffracted, or otherwise affected by one or more geologic structures. For example, when the wave encounters an interface between different media in the earth's subsurface a portion of the wave is reflected back to the earth's surface while the remainder of the wave is refracted through the interface. Seismic imaging systems include one or more seismic sources that may be arranged in various configurations. For example, seismic sources may be placed at or near the earth's surface, on or within bodies of water, or below the earth's surface.

A “seismic source” may be used to generate seismic signals. A seismic signal that is deliberately generated by a seismic source at the direction of the seismic imaging system is referred to as a “controlled signal” or an “active signal,” and the images resulting from the processing of these signals are referred to as “controlled seismic data” or “active seismic data.”

Seismic receivers placed at or near the earth's surface, within bodies of water, or below the earth's surface in well-bores are able to receive the reflected waves and convert the displacement of the ground resulting from the propagation of the reflected waves into an electrical signal and transmit the electrical signals to a seismic data tool. The electrical signals are processed to generate information about the location and physical properties of the subsurface geologic structures that interacted with the seismic signal. An individual receiver may receive and transmit amplitude of the received signals as a function of time. Data representing an amplitude of the received signals as a function of time may be called a seismic trace. A set of seismic traces collected during a particular time period may be referred to as a “survey.” One or more seismic traces from a single survey may be used to generate an image of subsurface formations. Such images, referred to as “2D images” or “3D images,” indicate the state of the subsurface formations during the time period in which the survey was taken. Features of a 3D image related to the state of the subsurface formations may be considered “3D signal” or “3D signature” while other unwanted elements of the image may be considered “noise” or “3D noise.”

One common source of 3D noise are received signals that propagated over indirect paths between a source, a subsurface feature, and a receiver. Seismic sources generate seismic signals that propagate through the subsurface away from the source in multiple different directions. Some portion of these seismic signals propagate from the source towards a subsurface feature of interest, reflect off of that subsurface feature, and then propagate towards a receiver that receives the signal. Seismic signals that propagate in this manner from a source to a subsurface feature then to a receiver may be referred to as “primary reflections” or “primary waves” when received at the seismic receiver. Some portion of the seismic signals may propagate through other less direct routes. For example, if a seismic source is located below the surface of the earth, some portion of the seismic signal may propagate upward, reflect off the surface of the earth, then propagate to a subsurface feature and then propagate to a seismic receiver. Alternatively, if a seismic receiver is buried below the surface of the earth, some portion of a seismic signal may propagate from a seismic source to a subsurface feature, then propagate up to the surface of the earth, reflect, then propagate to the seismic receiver. Seismic signals that propagate between a source, a subsurface features, and a seismic receiver in this indirect manner may be referred to as “ghost waves” or “ghost reflections” when received by the seismic receiver. Ghost waves may be one type of signal that contributes 3D noise to a 3D seismic image.

In many survey areas, the speed at which seismic energy moves through the subsurface, known as the seismic velocity, varies with location or depth below the surface. In addition, in many survey areas, interfaces between different media in the earth, or “seismic reflectors,” are not positioned horizontally, but at a variety of dip angles. Such variable seismic velocities and dipping seismic reflectors cause images produced from raw seismic data to show seismic reflectors at incorrect locations. Such images may also show reflected seismic energy from a seismic reflector smeared across a surface such as a hyperbolic diffraction curve, rather than at a single point. As a result, during processing, some form of seismic migration is applied to the recorded data to focus energy spread out through the raw seismic data and to accurately position the subsurface seismic reflectors at the correct subsurface positions.

In many survey operations, the source and receiver are not positioned in the same location, but are offset by some distance. During processing, seismic traces may be combined to form a stacked data trace that simulates a zero-offset seismic trace. In post-stack migration, a migration technique is applied to the stacked data. In pre-stack migration, a migration technique is applied to each individual seismic trace and the migrated results are then stacked with the other migrated traces. Pre-stack migration often produces more accurate results than post-stack migration. However, pre-stack migration is more computationally expensive than post-stack migration.

3D images are typically generated from processing of migrated seismic traces measured from seismic sources. These 3D images may be analyzed to determine the properties of subsurface features. The portion of 3D image attributable to measurement of a reflected wave from a subsurface features may be referred to as a “stable primary reflection.” However, in certain systems, 3D noise may appear in one or more seismic traces as a result of ghost waves. These ghost waves may distort seismic images, causing 3D images from different surveys to show differences that result from near-surface variations rather than structural changes in the layers or reservoir that are relevant to production. The distortion in 3D images cause by ghost waves may obscure stable primary reflections.

Further, seismic data may be collected at different times. This type of analysis is referred to as “time-lapse” or “4D” imaging. “Permanent Reservoir Monitoring” (PRM), or “Continuous Reservoir Monitoring” (CRM) is used to perform 4D imaging near a reservoir over an extended period of time, though such implementations need not be permanent or continuous. Performance of 4D imaging may also be referred to as generating a “Calendar Seismic Record” (CSR).

4D processing of multiple seismic datasets corresponding to different times facilitates the determination of how and where the earth's properties have changed during that time period. Seismic datasets corresponding to different times are referred to as different “vintages.” Because 4D images are generated from seismic data acquired at different times, 4D images measure changes in subsurface formations over time. For example, 4D images may be developed for a reservoir before and after a period of production. Such 4D images are used to identify reservoir activity of interest such as, for example, fluid movements or changes in fluid or lithological properties in and around a reservoir. However, like 3D images, 4D images may additionally include recording of ghost waves or other passive signals. Features of a 4D image related to fluid production may be considered “4D signal” or “4D signature” while other unwanted elements of the image may be considered “4D noise.”

### SUMMARY

In accordance with some embodiments of the present disclosure, a method for deghosting seismic data includes obtaining input seismic data, the input seismic data including a first set of seismic data recorded by a first set of seismic receivers located at a first depth, and a second set of seismic data recorded by a second set of seismic receivers located at a second depth. The method further includes migrating the first set of seismic data to an image grid, and migrating the second set of seismic data to the image grid. Additionally, the method includes calculating a ghost wave based on the first and second sets of migrated seismic data, and deghosting the first set of migrated seismic data by removing the ghost wave.

In accordance with some embodiments of the present disclosure, a seismic data system for deghosting seismic data includes a processor, a memory communicatively coupled to the processor, a first set of seismic receivers located at a first depth, a second set of seismic receivers located at a second depth, the second depth below the first depth, and a seismic source. The system further includes instructions stored in the memory that, when executed by the processor, cause the processor to obtain input seismic data, the input seismic data including a first set of seismic data recorded by the first set of seismic receivers and a second set of seismic data recorded by the second set of seismic receivers. The instructions further cause the processor to migrate the first set of seismic data to an image grid, and migrate the second set of seismic data to the image grid. Additionally, the instructions cause the processor to calculate a ghost wave based on the first and second sets of migrated seismic data and deghost the first set of migrated seismic data by removing the ghost wave.

In accordance with some embodiments of the present disclosure, a non-transitory computer-readable medium includes instructions that, when executed by a processor, cause the processor to obtain input seismic data, the input seismic data including a first set of seismic data recorded by a first array of seismic receivers located at a first depth and a second set of seismic data recorded by a second set of seismic receivers located at a second depth, the second depth below the first depth. The instruction further cause the processor to migrate the first set of seismic data to an image grid, and migrate the second set of seismic data to the image grid. Additionally, the instructions cause the processor to calculate a ghost wave based on the first and second sets of migrated seismic data, and deghost the first set of migrated seismic data by removing the ghost wave.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates an exemplary top view of an array of seismic sources and seismic receivers in an exploration area in accordance with some embodiments of the present disclosure;

FIG. 2A illustrates a cross-sectional side view of an array including dense seismic equipment and two layers of sparse seismic equipment in accordance with some embodiments of the present disclosure;

FIG. 2B illustrates a cross-sectional side view of an array including dense seismic equipment and one layer of sparse seismic equipment above the dense seismic equipment in accordance with some embodiments of the present disclosure;

FIG. 2C illustrates a cross-sectional side view of an array including dense seismic equipment and one layer of sparse seismic equipment below the dense seismic equipment in accordance with some embodiments of the present disclosure;

FIG. 2D illustrates a cross-sectional side view of an array including dense seismic equipment disposed in a horizontal wellbore and one layer of sparse seismic equipment in accordance with some embodiments of the present disclosure;

FIG. 3 illustrates the propagation of an exemplary seismic wave propagation in accordance with some embodiments of the present disclosure;

FIG. 4 illustrates graphs of unmigrated seismic signals recorded by dense seismic equipment and by sparse seismic equipment in accordance with some embodiments of the present disclosure;

FIG. 5A illustrates an operational sequence for calculating a ghost wave in accordance with some embodiments of the present disclosure;

FIG. 5B illustrates a method of calculating a ghost wave as discussed in FIG. 5A in accordance with some embodiments of the present disclosure;

FIG. 6A illustrates an operational sequence for calculating a time-variable change in seismic data in accordance with some embodiments of the present disclosure;

FIG. 6B illustrates a method of calculating a time-variable change in seismic data as discussed in FIG. 6A in accordance with some embodiments of the present disclosure;

FIG. 7 illustrates a flow chart of an exemplary method for deghosting seismic data using migration of sparse vertical arrays in accordance with some embodiments of the present disclosure;

FIG. 8 illustrates a cross-sectional view of a seismic imaging system 800 that may be used to generate seismic signal data, in accordance with some embodiments of the present disclosure; and

FIG. 9 illustrates a schematic of an exemplary system for reducing noise in input seismic data, in accordance with some embodiments of the present disclosure.

### DETAILED DESCRIPTION

Embodiments of the present disclosure may utilize multiple layers of seismic equipment to deghost migrated seismic data. For example, sparse arrays of seismic receivers and seismic sources may be used to deghost migrated seismic data collected by dense seismic equipment. Ghost waves may cause 3D noise and 4D noise in 3D and 4D seismic images, respectively. Removing the effect of a ghost wave (either totally or partially) from a 3D or 4D seismic image may be referred to as “deghosting.” Deghosting seismic data may improve the visibility of subsurface features by removing ghost waves from seismic data and consequently reducing 3D noise and 4D noise. In some embodiments, arrays of sparse seismic equipment may be used to perform deghosting on data collected by an array of dense seismic equipment. Dense seismic equipment may include an array of seismic sources and seismic receivers located at a first depth. Sparse seismic equipment may include less dense arrays of seismic sources and seismic receivers disposed in a configuration at least at a second depth. Seismic receivers in sparse seismic equipment and dense seismic equipment may receive the same reflected waves. However, because the sparse seismic equipment and the dense seismic equipment are located at different depths, the reflected waves, including ghost waves and primary waves, may be recorded at different times. For example, for a given seismic receiver, an upgoing reflected wave may reach the deepest equipment first, while a downgoing reflected wave will reach the shallowest equipment first.

By analyzing the times at which various reflected waves are received by equipment installed at various depths, a ghost wave may be identified and removed from the seismic data. Using sparse seismic equipment to identify a ghost wave allows for accurate deghosting while minimizing the amount of required seismic equipment. To facilitate the process of deghosting seismic data, signals received by the sparse seismic equipment, or “sparse seismic data” may be migrated to the same image point as signals received by the dense seismic equipment, or “dense seismic data.” Thus, although sparse seismic equipment may be distributed less densely as compared to dense seismic equipment, the image points for the sparse seismic equipment may be selected to be the same as the image points for the dense seismic equipment. Migrating the sparse seismic data and the dense seismic data to the same image point locations may result in a one-to-one mapping of migrated seismic traces collected by seismic receivers in dense seismic equipment and sparse seismic equipment. Performing migration before deghosting may also provide a high level of noise reduction as the migration process itself de-noises seismic data by summing together data from different traces. After seismic data is deghosted, a time lapse variation of the deghosted seismic data may be calculated. A time lapse variation may highlight time variable properties of subsurface features within a seismic image.

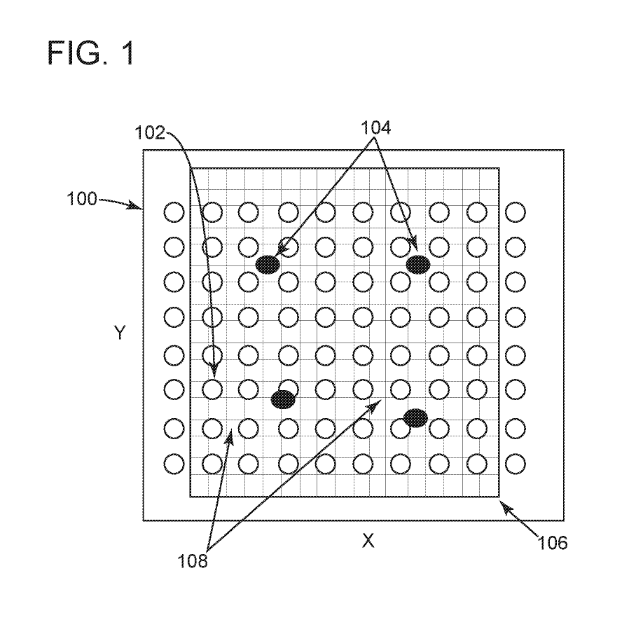

FIG. 1 illustrates an exemplary top view of an array of seismic sources and seismic receivers in an exploration area in accordance with some embodiments of the present disclosure. To collect seismic imaging data, arrays of seismic sources and seismic receivers, also referred to as “seismic equipment,” may be placed at a geographic location proximate to a subsurface area of interest for seismic exploration. For example, as depicted in FIG. 1, dense seismic equipment 102 and sparse seismic equipment 104 may be positioned within exploration area 100. In some embodiments, dense seismic equipment 102 includes seismic equipment disposed at a first depth below the surface of the earth. Dense seismic equipment 102 may include any suitable combination of seismic sources and seismic receivers. In some embodiments, each piece of seismic equipment included in dense seismic equipment 102 may be located at approximately the same depth at or below the surface of the earth. The configuration of dense seismic equipment 102 depicted in FIG. 1 is exemplary, and many other configurations are possible. For example, as shown in FIG. 1, dense seismic equipment 102 is distributed in a grid formation. However, in some embodiments, dense seismic equipment 102 may disturbed in any regular pattern that follows a repeated spatial motif. Additionally, in some embodiments, dense seismic equipment 102 may be distributed in an irregular pattern, including a random distribution.

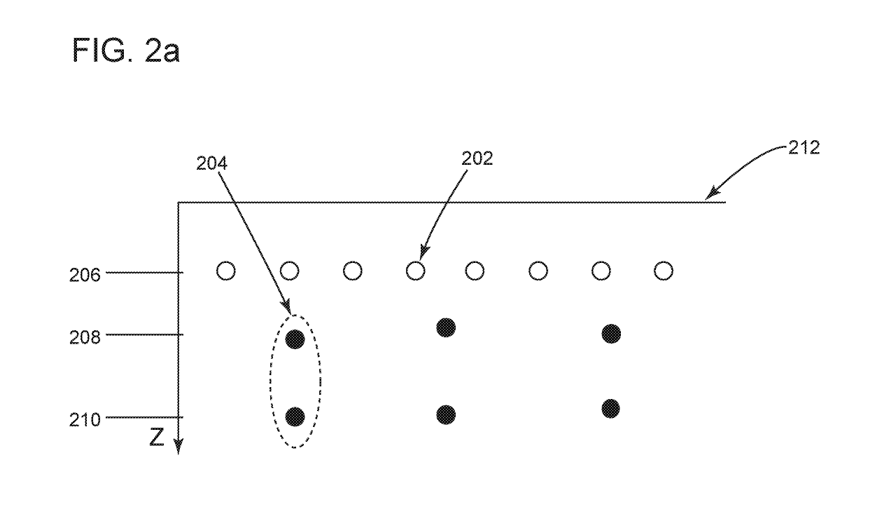

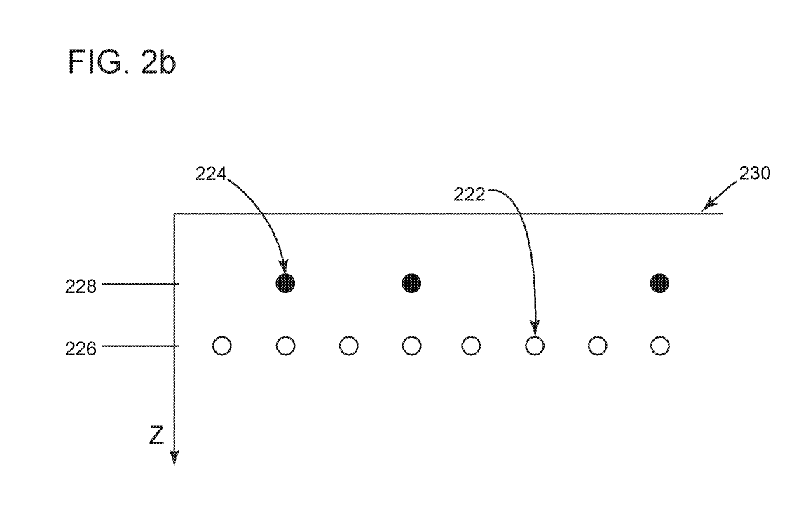

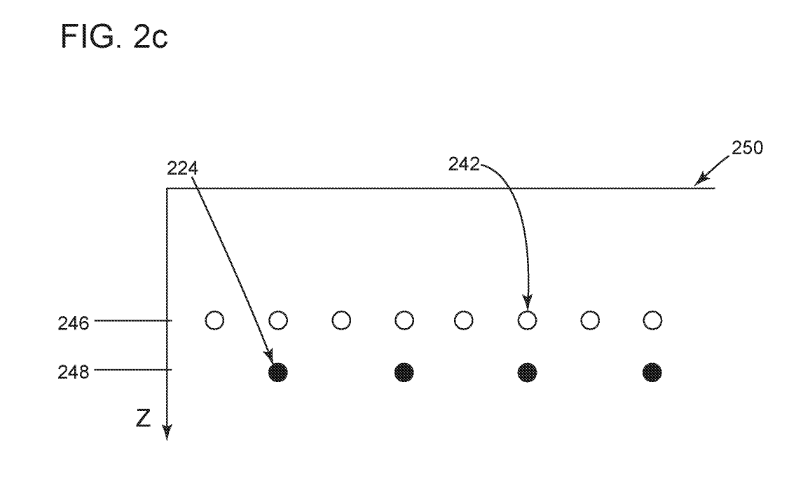

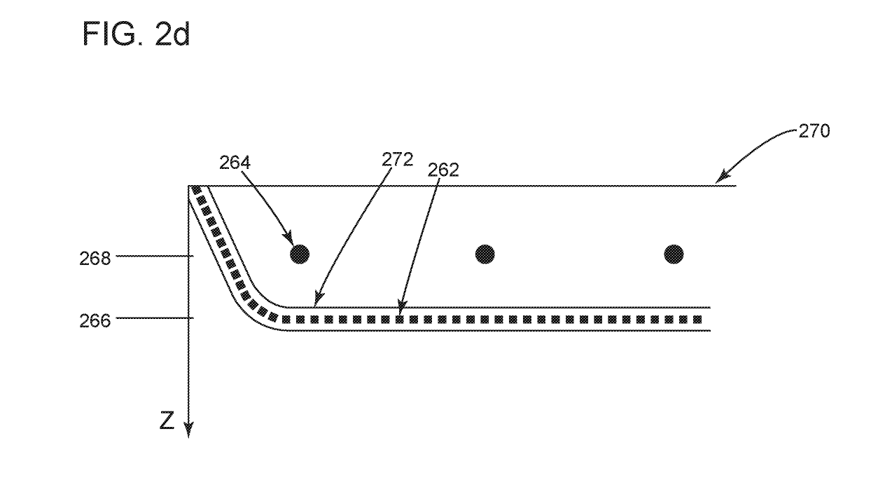

In some embodiments, sparse seismic equipment 104 may include arrays of seismic equipment. For example, each instance of sparse seismic equipment 104, may include one or more levels of seismic equipment. The disposition of the layers of sparse seismic equipment 104 is described in further detail below with reference to FIGS. 2A-2D. Sparse seismic equipment 104 may include any suitable combination of seismic sources and seismic receivers. The spatial distribution of sparse seismic equipment 104 within exploration area 100 may be less dense than the spatial distribution of dense seismic equipment 104. The distribution of sparse seismic equipment may be in a regular pattern, such as a grid or following a repeated spatial motif, or may be in an irregular or random pattern.

Image grid 106 may be a conceptual representation of image points 108 into which acquired seismic data may be migrated. In some embodiments, the resolution of image points 108 may be selected based on the distribution of dense seismic equipment 102. For example, image points 108 in image grid 106 may be selected to be approximately midway (in both the X and Y directions) between two pieces of equipment in dense seismic equipment 102. Although sparse seismic equipment 104 may not have the same resolution as dense seismic equipment 102, data acquired by both sparse seismic equipment 104 and dense seismic equipment 102 may be migrated to the same image grid 106. Migration to the same image grid 106 may create a one-to-one mapping of migrated seismic traces collected by seismic receivers in dense seismic equipment 102 and sparse seismic equipment 104.

FIG. 2A illustrates a cross-sectional side view of an array including dense seismic equipment and two layers of sparse seismic equipment in accordance with some embodiments of the present disclosure. In some embodiments, data acquired by two layers of sparse seismic equipment may be used to deghost data acquired by a layer of dense seismic equipment. As described above with reference to FIG. 1, dense seismic equipment 202 may be disposed at or below the surface of the earth. Dense seismic equipment 202 may include both seismic sources and seismic receivers. Dense seismic equipment 202 may be disposed at first depth 206 below the surface of the earth. Sparse seismic equipment 204 may include one or more arrays of seismic equipment. Each instance of sparse seismic equipment 204, may include one or more levels of seismic equipment, such as, seismic sources or seismic receivers. For example, sparse seismic equipment 204 may include a layer of seismic equipment disposed at second depth 208 below surface of the earth 212. Sparse seismic equipment 204 may additionally include a second layer of seismic equipment located at third depth 210 below surface of the earth 212. In some embodiments, an array of sparse seismic equipment 204 may be located vertically beneath or above a piece of dense seismic equipment 202. However, arrays of sparse seismic equipment 204 may also be located interstitially between pieces of dense seismic equipment 202.

FIG. 2B illustrates a cross-sectional side view of an array including dense seismic equipment and one layer of sparse seismic equipment above the dense seismic equipment in accordance with some embodiments of the present disclosure. In some embodiments, data acquired by one layer of sparse seismic equipment located above a layer of dense seismic equipment may be used to deghost data acquired by the dense seismic equipment. For example, dense seismic equipment 222 may be located at first depth 226. Sparse seismic equipment 224 may be located second depth 228, which is above first depth 226. Both first depth 226 and second depth 228 may be below surface of the earth 230 and above the reservoir level.

FIG. 2C illustrates a cross-sectional side view of an array including dense seismic equipment and one layer of sparse seismic equipment below the dense seismic equipment in accordance with some embodiments of the present disclosure. In some embodiments, data acquired by one layer of sparse seismic equipment located below a layer of dense seismic equipment may be used to deghost data acquired by the dense seismic equipment. For example, dense seismic equipment 242 may be located at first depth 246. Sparse seismic equipment 244 may be located second depth 248, which is below first depth 246. Both first depth 246 and second depth 248 may be below surface of the earth 250 and above the reservoir level.

FIG. 2D illustrates a cross-sectional side view of an array including dense seismic equipment disposed in a horizontal wellbore and one layer of sparse seismic equipment in accordance with some embodiments of the present disclosure. In some embodiments, a layer of dense seismic equipment 262 may be disposed within horizontal wellbore 272. A horizontal portion of wellbore 262 may be located at first depth 266. Sparse seismic equipment 264 may be located at a second depth 268. Although second depth 268 is depicted in FIG. 2D to be less than first depth 266, in some embodiments, second depth 268 may be greater than first depth 266. Both first depth 266 and second depth 268 may be below surface of the earth 270 and above the reservoir level.

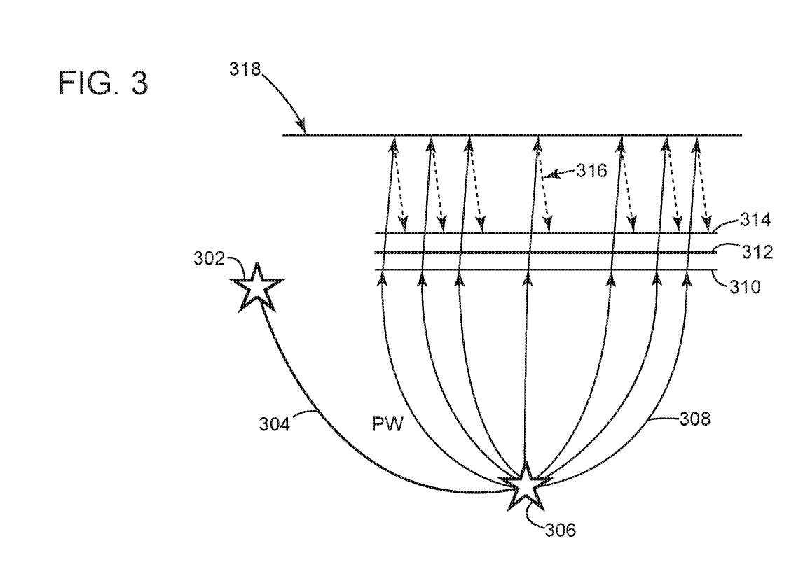

FIG. 3 illustrates the propagation of an exemplary seismic wave propagation in accordance with some embodiments of the present disclosure. Dense seismic equipment may be disposed at first depth 314, and sparse seismic equipment may be disposed at second depth 312 and third depth 310, as discussed with reference to FIG. 2A. In some embodiments, seismic source 302 at first depth 314 may emit seismic wave 304. Seismic wave 304 may propagate through the subsurface of the earth to subsurface feature 306. Subsurface feature 306 may include any heterogeneity within the subsurface of the earth. For example, subsurface feature 306 may be an subsurface reservoir. When seismic wave 304 impacts subsurface feature 306, subsurface feature 306 reflects some portion of seismic wave 304. For example, subsurface features may act as a conceptual secondary seismic source that emits reflected waves in all directions. Portions of these reflected waves may propagate towards earth surface 318. These reflected waves may be referred to as primary waves. Primary wave 308 passes through the depths where the sparse seismic equipment and dense seismic equipment are disposed. For example, primary wave 308 passes through third depth 310, then through second depth 312, and then through first depth 314. Accordingly, seismic receivers located at third depth 310 may record primary wave 308 before seismic receivers located at second depth 312, and before seismic receivers located at first depth 314. Portions of primary wave 308 may reflect off earth surface 318 and back down through the depths where the sparse seismic equipment and dense seismic equipment are disposed. These reflected waves may be referred to as ghost wave 316. Ghost wave 316 may pass first through first depth 314, then through second depth 312, and then through third depth 310. Accordingly, seismic receivers located at first depth 314 may record ghost wave 316 before seismic receivers located a second depth 312, and before seismic receivers located at third depth 310. The order of arrival of these various waves at layers of different equipment may vary according to the depth of each layer. The exemplary system depicted in FIG. 3 includes one layer of dense seismic equipment and two layers of sparse seismic equipment, as described above with reference to FIG. 2A. However, the exemplary wave propagation described herein may be equally applicable to any combination of layers of dense seismic equipment and sparse seismic equipment, such as those described above with reference to FIGS. 2A-2D.

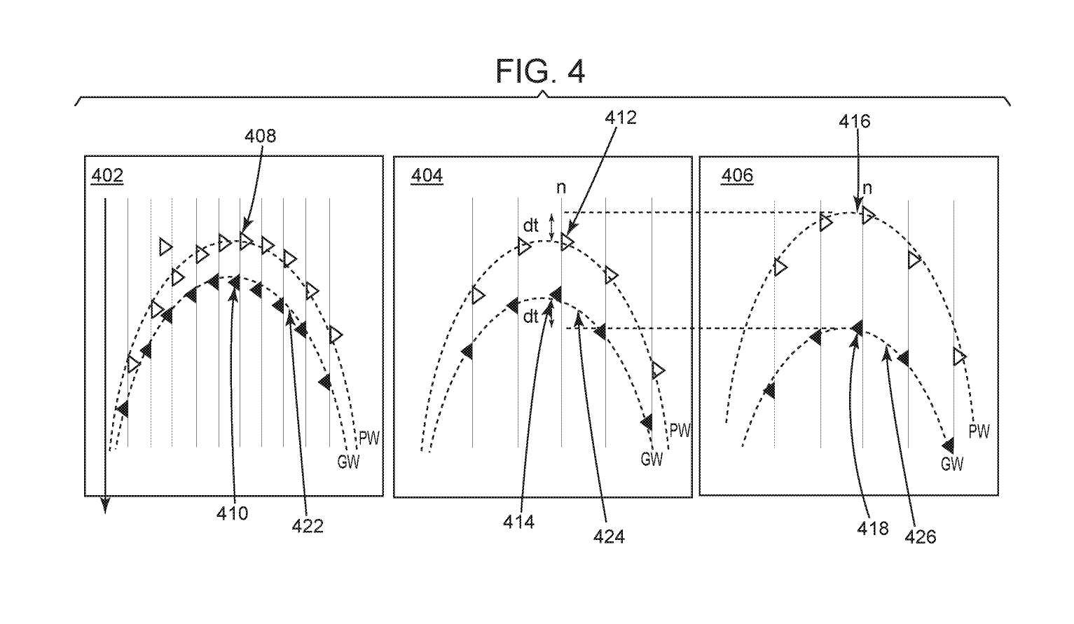

FIG. 4 illustrates graphs of unmigrated reflected signals recorded by dense seismic equipment and by sparse seismic equipment in accordance with some embodiments of the present disclosure. Plots 402, 404 and 406 illustrate exemplary seismic data recorded by dense seismic equipment and sparse seismic equipment. Each vertical line represents a seismic trace recorded by a seismic source and seismic receiver pair. The vertical axis represents increasing two-way time, or depth, from the top to the bottom of the plot. Plot 402 illustrates exemplary seismic data recorded by dense seismic equipment. Dense seismic equipment may record numerous seismic traces, only a subset of which are shown in plot 402. For example, plot 402 may show a subset of traces recorded by dense seismic equipment that share a common image point. Each trace in plot 402 includes a measurement of primary wave 408 and a measurement of ghost wave 410. As described above with reference to FIG. 3, primary wave 408 reaches seismic receivers in dense seismic equipment before ghost wave 410. Plots 404 and 406 illustrate seismic traces recorded by the layers of sparse seismic equipment. Because there may be comparatively fewer pieces of sparse seismic equipment (as compared to dense seismic equipment), plots 404 and 406 may include fewer traces than plot 402. The traces in plots 404 and 406 may share the same common image point with the traces in plot 402. Because layers of seismic equipment are located at different depths, primary waves and ghost waves may arrive at different layers at different times. For example, primary wave 416 arrives earlier than primary wave 412, which in turn arrives earlier than primary wave 408. Likewise, ghost wave 418 arrives after ghost wave 414, which in turn, arrives after ghost wave 410.

In practice, seismic traces contain noise that may interfere with identification and visualization of the subsurface reflectors. Accordingly, multiple seismic traces may be combined into a single stacked trace with a higher signal-to-noise ratio. However, because the points on reflection curves, each of which corresponds to reflections from a single subsurface reflector, do not fall at the same time in each seismic trace, simply summing a measured value from the same point in time from each raw seismic trace in a shot gather fails to fully combine the energy reflected by each subsurface reflector. Seismic migration corrects the times of each sample in each seismic trace to position the points corresponding to reflections from a single subsurface reflector at the proper time. Once the traces have been migrated in time, a weighted sum of the traces at each migrated time is performed to create a set of migrated data traces that may be incorporated into the 2D or 3D subsurface image. The value of the proper time correction and the proper weighting value used in the weighted sum are determined in part by the velocity of seismic signals through the subsurface in the survey area. Because the exact velocity may not be known at all locations, in some embodiments, the velocity at which seismic signals propagate through the subsurface in the survey area may be estimated using a velocity model. The velocity model may include a single predicted velocity for all locations. In some embodiments, the velocity model may be smooth or may vary as a function of depth below the surface. Such a velocity model may represent a series of horizontal layers within the entire survey area. In some embodiments, the velocity model may also vary based on one or more factors such as surface location, direction of propagation, or other suitable factors. A velocity model may be defined by the survey operators, estimated based on previous surveys of the survey area, or calculated in any other suitable manner. As depicted in FIG. 4, migration may be performed on the data in plots 402, 404, and 406 by summing the traces in each plot along calculated migration curves 424, 426 and 428, respectively. However, unlike uncorrelated noise sources, ghost waves are typically not minimized through migration and stacking. Rather, because the curve of the ghost waves is approximately parallel to the curve of the primary waves, migrating the seismic data may additively combine both ghost waves and primary wave. Accordingly, after seismic data is migrated, it may be deghosted. The exemplary data depicted in FIG. 4 includes one layer of dense seismic equipment and two layers of sparse seismic equipment, as described above with reference to FIG. 2A. However, the operations described herein may be equally applicable to any combination of layers of dense seismic equipment and sparse seismic equipment, such as those described above with reference to FIGS. 2A-2D.

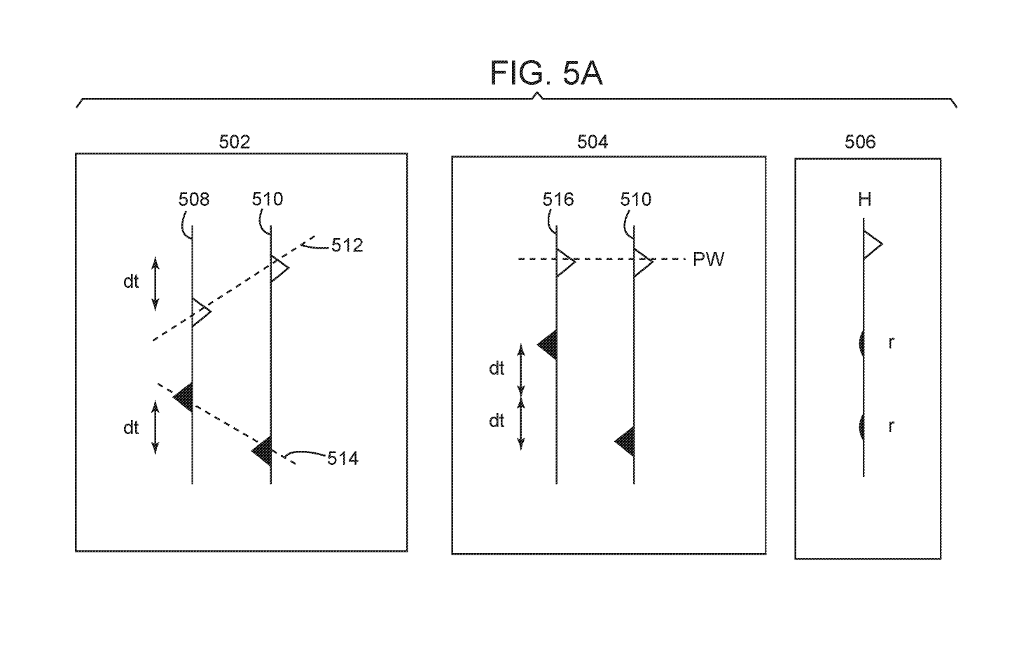

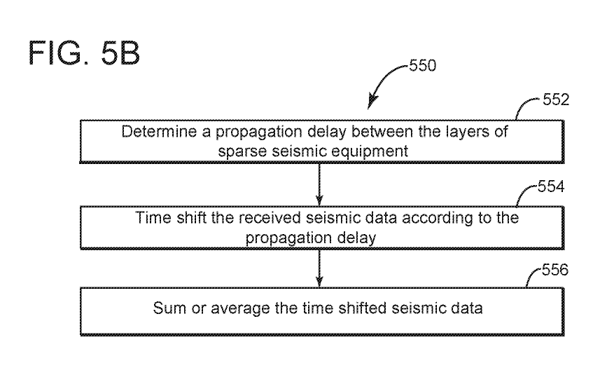

FIG. 5A illustrates an operational sequence for calculating a ghost wave in accordance with some embodiments of the present disclosure. Operational sequence 500 is provided as an example, and various embodiments may perform all, some, or none of these steps. Operational sequence 500 sequence may also be repeated any suitable number of times to reduce noise in seismic trace associated with different surveys performed at different time periods. Although operational sequence 500 is described as using data acquired by two layers of sparse seismic equipment to deghost data acquired by a layer of dense seismic equipment, any suitable combination or configures of layers of seismic equipment may be used.

In operational block 502, a propagation delay between the layers of sparse seismic equipment (or between layers of dense seismic equipment and sparse seismic equipment) may be determined. A propagation delay may be determined by calculating a position difference between two layers of seismic equipment and using estimated wave velocities. For example, determining a position difference may include accessing GPS data for the seismic sources and seismic receivers in the layers of sparse seismic equipment. In some embodiments, an average equipment depth may be calculated for each layer of seismic equipment. The average depths may be subtracted to calculate a position difference. The position difference may be converted into a propagation delay by dividing the position difference by an estimated seismic signal velocity. In some embodiments, the propagation delay is computed directly from synchronized seismic traces. For example, seismic traces 508 and 510 may represented migrated seismic data collected by two different layers of sparse seismic equipment. Seismic traces 508 and 510 may each include primary wave 512 and ghost wave 514. Because the layers of sparse seismic equipment are located at different depths, the time at which primary wave 512 and ghost wave 514 reaches each level of sparse seismic equipment is different. A propagation delay may be measured directly by calculating the time delay between the primary wave and ghost wave at each layer of seismic equipment. The difference between these times is equal to twice the propagation delay.

In operational block 504, the received seismic data may be time shifted according to the propagation delay. For example, adjusted seismic trace 516 may be calculated by adding an time delay (or “offset”) equal to the propagation delay to seismic trace 508. Time shifting the seismic data according to the position difference or the propagation delay may align the primary waves within the seismic data and thereby provide aligned seismic data.

In operational block 506, time shifted seismic data may be summed or averaged. Because the time shift aligns the primary waves, but not the ghost wave, the summed traces may emphasize the primary wave while minimizing the ghost wave. Operational blocks 504 and 506 may be accomplished with a digital or analog filter.

Sparse seismic data may also be deghosted mathematically. Mathematically, the seismic data corresponding to a plural depth source or receiver spread may be represented in the frequency domain as:

S₁(f)=P₁(f)+G₁(f) (1)

S₂(f)=P₂(f)+G₂(f) (2)

where f is a selected frequency, S₁ and S₂ represent signals recorded by layers of seismic equipment, P₁ and P₂ represent up-going or primary waves that occur at those depths, and G₁ and G₂ represent downgoing or ghost waves. The relationship between upgoing waves P and downgoing waves G at the two depths may be represented as:

τ=e^{-i2π(dt)} (3)

dt=Δz/V (4)

where f is the frequency component of the signal, τ is a phase term corresponding to the arrival time difference dt between the two levels of sources or seismic receivers separated by the depth difference Δz, and V is the propagation velocity between the two levels of sources or seismic receivers.

Assuming that there is no absorption between the two levels, which is a reasonable assumption in a consolidated media, and that Δz is in the order of a few meters, the relationship between up-going wave P and the down-going waves G at the two levels may be written as:

G₂(f)=G₁(F)/τ (5)

P₂(f)=τ·P₁(f) (6)

P₁(f)=[S₁(f)−S₂(f)/τ]/[1−(1/π²] (7)

G₁(f)=[S₁(f)−τ·S₂(f)]/[1−τ²] (8)

Accordingly, based on measurements obtained by layers of seismic equipment and an estimate of the velocity (V) through the media, a primary wave and ghost wave may be separately calculated.

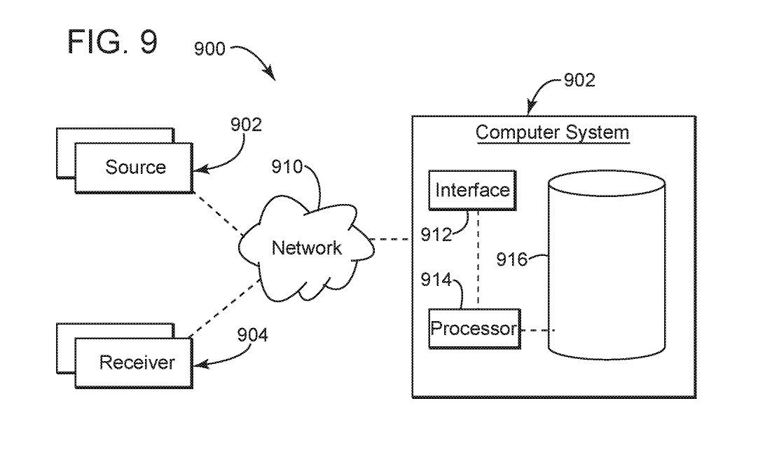

FIG. 5B illustrates a method of calculating a ghost wave as discussed in FIG. 5A in accordance with some embodiments of the present disclosure. Method 550 is provided as an example, and various embodiments may perform all, some, or none of these steps. The steps of method 550 are performed by a user, various computer programs, models configured to process or analyze seismic data, or any combination thereof. For example, the steps of method 550 may be performed by a seismic data tool, such as seismic computing system 902, discussed below with reference to FIG. 9. Furthermore, although method 550 is described as using data acquired by two layers of sparse seismic equipment to deghost data acquired by a layer of dense seismic equipment, any suitable combination or configures of layers of seismic equipment may be used. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “seismic computing system.” Certain embodiments may perform different steps in addition to or in place of the illustrated steps discussed below. Method 550 may also be repeated any suitable number of times to reduce noise in input seismic data associated with different surveys performed at different time periods.

At step 552, a seismic computing system determines a propagation delay between the layers of sparse seismic equipment. A propagation delay may be determined by calculating a position difference between layers of sparse seismic equipment and using estimated wave velocities. For example, determining a position difference may include accessing GPS data for the seismic sources and seismic receivers in the layers of sparse seismic equipment. An average equipment depth may be calculated for each layer of sparse seismic equipment. The average depths may be subtracted to calculate a position difference. The position difference may be converted into a propagation delay by dividing the position difference by an estimated seismic signal velocity. In some embodiments. the propagation delay is computed directly from synchronized seismic traces. For example, seismic traces 508 and 510 may represented migrated seismic data collected by two different layers of sparse seismic equipment. Seismic traces 508 and 510 may each include primary wave 512 and ghost wave 514. Because the layers of sparse seismic equipment are located at different depths, the time at which primary wave 512 and ghost wave 514 reaches each level of equipment is different. A propagation delay may be measured directly by calculating the time delay between the primary wave and ghost wave at each layer of sparse seismic equipment. The difference between these times is equal to twice the propagation delay.

At step 554, a seismic computing system time shifts the received seismic data according to the propagation delay. For example, adjusted seismic trace 516 may be calculated by adding a time delay equal to the propagation delay to seismic trace 508. Time shifting the seismic data according to the position difference or the propagation delay may align the primary reflections within the seismic data and thereby provide aligned seismic data.

At step 556, a seismic computing system sums or averages the time shifted seismic data. Because the time shift aligns the primary waves, but not the ghost wave, the summed traces may emphasize the primary wave while minimizing the ghost wave. Steps 554 and 556 may be accomplished with a digital filter that includes one or more taps corresponding to phase shift terms.

Various embodiments may perform some, all, or none of the steps described above. For example, certain embodiments may perform certain steps in different orders or in parallel, and certain embodiments may modify one or more steps. For example, multiple sets of seismic signals may be processed in parallel. Moreover, one or more steps may be repeated. Additionally, while a computing system has been described as performing these steps, any suitable component of systems may perform one or more steps. For example, seismic computing system 902 (shown in FIG. 9) may perform all or some of the steps described above.

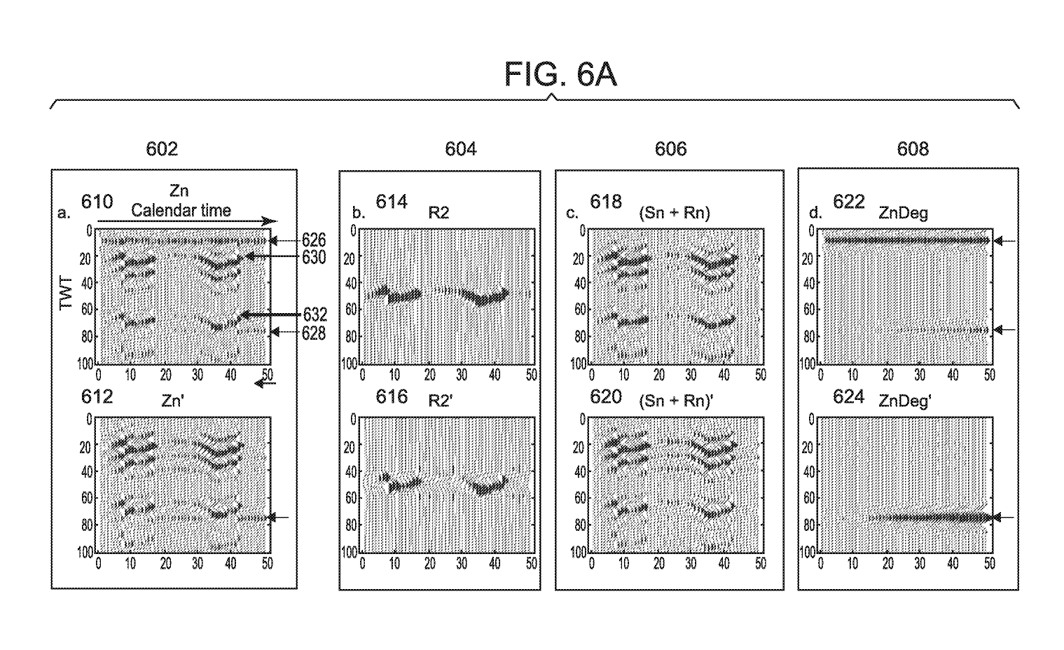

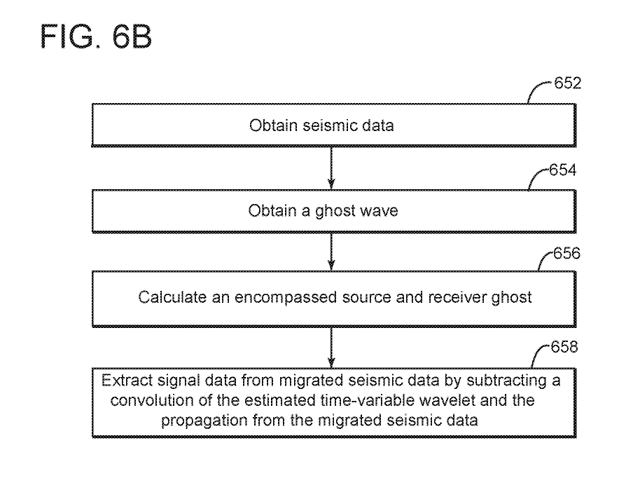

FIG. 6A illustrates an operational sequence for calculating a time-variable change in seismic data in accordance with some embodiments of the present disclosure. A time-variable change in seismic data may include a change in sub-surface feature properties between 3D images in a calendar seismic record. Once a ghost wave has been calculated, that ghost wave may be removed from repeated seismic data. After repeated seismic data has been deghosted, a variation of repeated seismic data may be calculated to illustrate the time variable changes in a reservoir or other subsurface feature. A variation may be calculated by subtracting the mean or median trace over the whole calendar period from each of the repeated traces of the input. For each of the plots in FIG. 6A, the x-axis is the calendar time, while the y-axis is the two-way-time, increasing from top to bottom. Operational sequence 600 is provided as an example, and various embodiments may perform all, some, or none of these steps. Operational sequence 600 sequence may also be repeated any suitable number of times to reduce noise in seismic traces associated with different surveys performed at different time periods. Although operational sequence 600 is described as using data acquired by two layers of sparse seismic equipment to deghost data acquired by a layer of dense seismic equipment, any suitable combination or configures of layers of seismic equipment may be used.

At operational block 602, a seismic computing system may obtain raw seismic data from dense seismic equipment. Plot 610 illustrates this seismic data, while plot 612 illustrates the variation in this seismic data. For example, migrated seismic data may be obtained by migrating data acquired from dense seismic equipment as described above with reference to FIG. 4. Plot 610 includes stable primary reflections 626 and 628. By contrast, ghost reflection 630 is time variable. In the bottom part of plot 610, stable primary reflection 682 is partially obscure by ghost reflection 632. In plot 612, because the shallow reflection is stable, it disappears when looking at variation. The variation of the target reflection 634 is unclear.

At operational block 604, a seismic computing system may obtain a ghost wave. Plot 614 illustrates the ghost wave, while plot 614 illustrates the variation in the ghost wave. A ghost wave may be calculated from seismic data according to the method described above with reference to FIGS. 5A and 5B.

At operational block 606, a seismic computing system may calculate an encompassed source and receiver ghost. A ghost wave may be represented as a convolution of a wavelet and a propagation operator. Both the wavelet and the propagation operator may be variable in time, however, it has been found that the it is reasonable to assume that the wavelet varies in time while the propagator is constant in time. This propagator may be assumed to be constant over the calendar time (i.e., over all the measurements), and is determined by solving an inverse problem using the repeated seismic data and the estimated time-variable wavelet. For example, if rsr is the repeated seismic data of m measurements, each measurement having n samples, RSR is a Fourier transform of rsr, Y=RSR^{T}, pwu is pure unwanted wave, PWU is a Fourier transform of pwu, G=PWU^{T}, then, in the frequency domain, a Fourier transform X of the propagation p is X=(G^{T}G)⁻¹·G^{T}Y.

At operational block 608, a seismic computing system may extract signal data from migrated seismic data by subtracting a convolution of the estimated time-variable wavelet and the propagation from the migrated seismic data. For example, following the notation described above at step 606, where tr is the signal data in time domain and TR is the Fourier transform of tr, TR=RSR−(PWU·X). As shown in plot 622, this operation removes the ghost reflections, leaving only repeated seismic data showing subsurface features. Plot 624 illustrates the variation of the deghosted data. Because the shallow reflector is unchanging over time, it is not visible in the variation of the deghosted data. Only changes in the deep reflector (the reservoir) are visible.

FIG. 6B illustrates a method of calculating a time-variable change in seismic data as discussed in FIG. 6A in accordance with some embodiments of the present disclosure. Method 650 is provided as an example, and various embodiments may perform all, some, or none of these steps. The steps of method 650 are performed by a user, various computer programs, models configured to process or analyze seismic data, or any combination thereof. For example, the steps of method 650 may be performed by a seismic data tool, such as seismic computing system 902, discussed below with reference to FIG. 9. Additionally, the steps of method 650 may be applied to either migrated or unmigrated seismic data. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “seismic computing system.” Certain embodiments may perform different steps in addition to or in place of the illustrated steps discussed below. Method 650 may also be repeated any suitable number of times to reduce noise in input seismic data associated with different surveys performed at different time periods.

At step 652, a seismic computing system obtains seismic data. Plot 610 illustrates this seismic data, while plot 612 illustrates the variation in this seismic data. For example, migrated seismic data may be obtained by migrating raw seismic data acquired from dense seismic equipment as described above with reference to FIG. 4.

At step 654, a seismic computing system obtains a ghost wave. Plot 614 illustrates the ghost wave, while plot 614 illustrates the variation in the ghost wave. A ghost wave may be calculated from seismic data according to the method described above with reference to FIGS. 5A and 5B.

At step 656, a seismic computing system calculates an encompassed source and receiver ghost. A ghost wave may be represented as a convolution of a wavelet and a propagation operator. Both the wavelet and the propagation operator may be variable in time, however, it has been found that the it is reasonable to assume that the wavelet varies in time while the propagator is constant in time. This propagator may be assumed to be constant over the calendar time (i.e., over all the measurements), and is determined by solving an inverse problem using the repeated seismic data and the estimated time-variable wavelet. For example, if rsr is the repeated seismic data of m measurements, each measurement having n samples, RSR is a Fourier transform of rsr, Y=RSR^{T}, pwu is pure unwanted wave, PWU is a Fourier transform of pwu, G=PWU^{T}, then, in the frequency domain, a Fourier transform X of the propagation p is X=(G^{T}G)⁻¹·G^{T}Y.

At step 658, a seismic computing system extracts signal data from seismic data by subtracting a convolution of the estimated time-variable wavelet and the propagation from the seismic data. For example, following the notation described above at step 606, where tr is the signal data in time domain and TR is the Fourier transform of tr, TR=RSR−(PWU·X). As shown in plot 622, this operation removes the ghost reflections, leaving only repeated seismic data showing subsurface features. Plot 624 illustrates the variation of the deghosted data. Because the shallow reflector is unchanging over time, it is not visible in the variation of the deghosted data. Only changes in the deep reflector (the reservoir) are visible.

In some embodiments, method 650 iterates through steps 652-658, or a subset of steps 652-658 multiple times. The steps of method 650 may be performed either in the frequency domain or in the time domain. Processing seismic data in this manner may reduce noise attributable to ghost waves during repeated or continuous acquisition cycles so that 4D images reflect the state of the subsurface geology, which may improve the effectiveness and efficiency of reservoir production operations and reduce costs.

Various embodiments may perform some, all, or none of the steps described above. For example, certain embodiments may perform certain steps in different orders or in parallel, and certain embodiments may modify one or more steps. For example, multiple sets of seismic signals may be processed in parallel. Moreover, one or more steps may be repeated. Additionally, while a computing system has been described as performing these steps, any suitable component of systems may perform one or more steps. For example, seismic computing system 902 (shown in FIG. 9) may perform all or some of the steps described above.

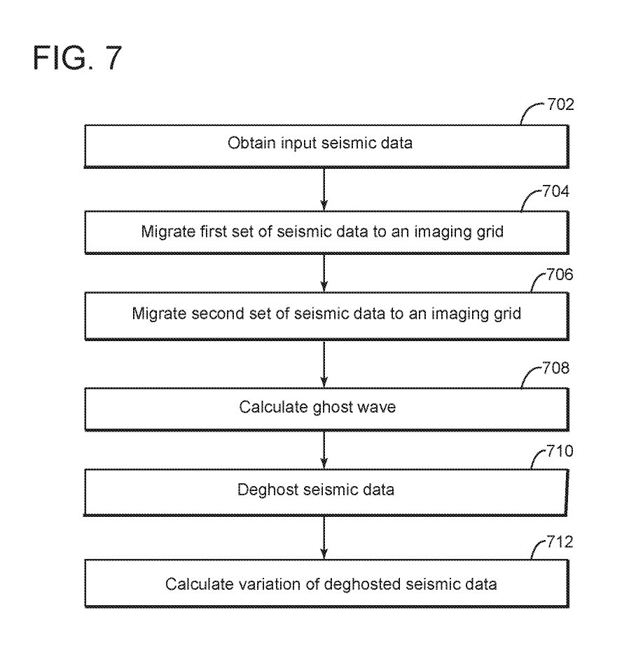

FIG. 7 illustrates a flow chart of an exemplary method for deghosting seismic data using migration of sparse arrays in accordance with some embodiments of the present disclosure. Method 700 is provided as an example, and various embodiments may perform all, some, or none of these steps. The steps of method 700 are performed by a user, various computer programs, models configured to process or analyze seismic data, or any combination thereof. For example, the steps of method 700 may be performed by a seismic data tool, such as seismic computing system 902, discussed below with reference to FIG. 9. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “seismic computing system.” Certain embodiments may perform different steps in addition to or in place of the illustrated steps discussed below. This sequence may also be repeated any suitable number of times to deghost seismic data associated with different surveys performed at different time periods.

At step 702, the seismic computing system obtains or receives input seismic data. Input seismic data may a first set of seismic data recorded by a first set of seismic receivers located at a first depth and a second set of seismic data recorded by a second set of seismic receivers located at a second depth. For example, input seismic data may include data from an array of dense seismic equipment located at a first depth, such as dense seismic equipment 102 or 202, described above with reference to FIGS. 1 and 2. Input seismic data may also include data from an array of sparse seismic equipment located at a second depth, such as sparse seismic equipment 104 or 204, described above with reference to FIGS. 1 and 2. Input seismic data may be received and transmitted to the computing system by seismic receivers. In some embodiments, signals may be received and transmitted to the computing system periodically. For example, signals may be received and transmitted to the computing system each day, week, month, year, or any suitable amount of time apart.

At step 704, the seismic computing system migrates the first set of seismic data to an image grid. For example, dense seismic data may be migrated to an image grid, such as 106, described above with reference to FIG. 1. Image grid 106 may include image points 108 located, for example, midway between pieces of dense seismic equipment.

At step 706, the seismic computing system migrates the second set of seismic data to an image grid. The second set of seismic data may be migrated to the same image grid as dense seismic data. For example, sparse seismic data may be migrated to image grid 106, which may correspond to the midpoints between pieces of seismic equipment in dense seismic equipment, with image bins located midway between pieces of dense seismic equipment.

At step 708, the seismic computing system calculates a ghost wave based on the first and second sets of migrated seismic data. A ghost wave may be calculated by time shifting the second set of migrated data as described above with reference to FIGS. 5A and 5B. Alternatively, a ghost wave may be calculated mathematically according to equations (1)-(8).

At step 710, the seismic computing system deghosts the first set of migrated seismic data. For example, seismic data may be deghosted according to the steps of method 650.

At step 712, the seismic computing system calculates a variation of the deghosted seismic data. A variation may be calculated by subtracting the mean or median trace over the whole calendar period from each of the repeated traces of the input. Calculating a variation of the deghosted seismic data may highlight the time variable changes in a seismic image of a subsurface feature

Various embodiments may perform some, all, or none of the steps described above. For example, certain embodiments may perform certain steps in different orders or in parallel, and certain embodiments may modify one or more steps. For example, multiple sets of seismic signals may be processed in parallel. Moreover, one or more steps may be repeated. Additionally, while a computing system has been described as performing these steps, any suitable component of systems may perform one or more steps. For example, seismic computing system 902 (shown in FIG. 9) may perform all or some of the steps described above.

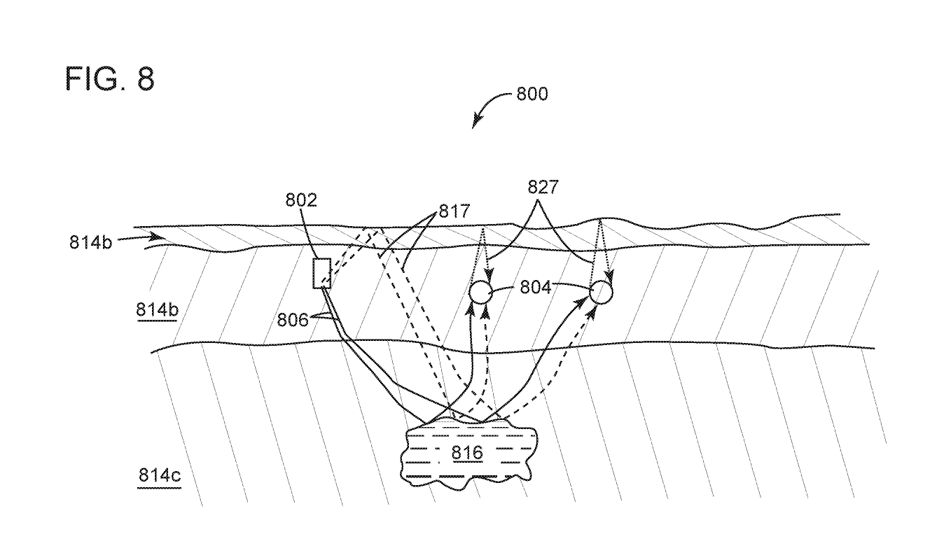

FIG. 8 illustrates a cross-sectional view of a seismic imaging system 800 that may be used to generate seismic signal data, in accordance with some embodiments of the present disclosure. In the illustrated embodiment, system 800 includes seismic source 802 and seismic receivers 804. Seismic receivers 804 may record and transmit seismic signals generated by seismic sources 802 to a seismic data tool. System 800 is located in an area that includes surface 812, layer 814a, layer 814b, and layer 814c (collectively “layers 814”), and reservoir 816. Although FIG. 8 depicts a land implementation of system 800, embodiments of the present disclosure may also be used in marine, transition zones, or in any other environment where seismic imaging is performed.

System 800 may deghost seismic data using migration of sparse arrays. System 800 may be any collection of systems, devices, or components configured to detect, record, or process seismic data. System 800 may include one or more seismic sources 802 and one or more seismic receivers 804. Seismic waves (such as, for example, acoustic wave trains) propagate out from one or more seismic sources 802 and may be partially reflected, refracted, diffracted, or otherwise affected by one or more subsurface structures such as rock layers beneath the earth's surface. These waves are ultimately received and transmitted to a seismic data tool by one or more seismic receivers 804 and processed to generate images of the subsurface. Each instance of a receiving and transmitting signals by receiver 804 may be called a seismic trace, or input seismic data. As explained above, input seismic data recorded at different locations may be used to generates 3D images. Further, 3D images taken at different calendar times may be compared to generate 4D images that show changes in subsurface formations over time.

Seismic sources 802 may be any devices that generate seismic waves that are used to generate images of geological structures. Seismic source 802, which may be impulsive or vibratory, generates seismic signals 806. In particular embodiments, seismic source 802 may be a seismic vibrator, vibroseis, dynamite, air gun, thumper truck, piezoelectric-source, or any other suitable seismic energy source. Source 802 may utilize electric motors, counter-rotating weights, hydraulics, piezoelectric, magnetostriction or any other suitable structure configured to generate seismic energy. System 800 may have any suitable number, type, configuration, or arrangement of seismic sources 802. For example, system 800 may include multiple seismic sources 802 that operate in conjunction with one another. In such embodiments, seismic sources 802 may be operated by a central controller that coordinates the operation of multiple seismic sources 802. As another example, seismic sources 802 may be located on surface 812, above surface 812, or below surface 812. Furthermore, in off-shore embodiments, seismic sources 802 may also be located above surface 812, at any suitable depth within the water. Furthermore, in some embodiments, a positioning system may be utilized to locate, synchronize, or time-correlate sources 802. For example, some embodiments utilize a Global Navigation Satellite System (GNSS) such as, for example, the Global Positioning System (GPS), Galileo, the BeiDou Satellite Navigation System (BDS), GLONASS, or any suitable GNSS system. Additional structures, configurations, and functionality of seismic sources 902 are described below with respect to FIG. 9.

In particular embodiments, seismic sources 802 are impulsive (such as, for example, explosives or air guns) or vibratory. Impulsive sources may generate a short, high-amplitude seismic signal while vibratory sources may generate lower-amplitude signals over a longer period of time. Vibratory sources may be instructed, by means of a pilot signal, to generate a target seismic signal with energy at one or more desired frequencies, and these frequencies may vary over time.

Deghosting of seismic data may also be performed in embodiments using seismic sources 802 that radiate one or more frequencies of seismic energy during predetermined time intervals. For example, some embodiments may use seismic sources 802 that generate monofrequency emissions such as, for example, certain SEISMOVIE sources. As another example, some embodiments may use seismic sources 802 that radiate varying frequencies. In such embodiments, seismic source 802 may impart energy at a starting frequency and the frequency may change over a defined interval of time at a particular rate until a stopping frequency is reached.

As explained above, reducing noise in seismic traces is not limited to particular types of seismic receivers 804. For example, in some embodiments, seismic receivers 804 include geophones, hydrophones, accelerometers, fiber optic sensors (such as, for example, a distributed acoustic sensor (DAS)), streamers, or any suitable device. Such devices may be configured to detect and record energy waves propagating through the subsurface geology with any suitable, direction, frequency, phase, or amplitude. For example, in some embodiments, seismic receivers 804 are vertical, horizontal, or multicomponent sensors. As particular examples, seismic receivers 804 may comprise three component (3C) geophones, 3C accelerometers, or 3C Digital Sensor Units (DSUs). In certain marine embodiments, seismic receivers 804 are situated on or below the ocean floor or other underwater surface.

Seismic receivers 804 may be any devices that are operable to receive and transmit seismic waves. Seismic receivers 804 convert seismic energy into signals, which may have any suitable format. For example, seismic receivers 804 may detect seismic waves as analog signals or digital signals. As a particular example, certain embodiments of receiver 804 convert seismic energy to electrical energy, allowing seismic waves to be detected as electrical signals such as, for example, voltage signals, current signals, or any suitable type of electric signal. Other embodiments of receiver 804 detect seismic energy as an optical signal or any suitable type of signal that corresponds to the received seismic energy. The resulting signals are transmitted to and recorded by recording units that may be local or remote to seismic receivers 804. The resulting recordings may be called input seismic data. Input seismic data may then be communicated to seismic computing system 902 for processing, as described further below with respect to FIG. 9.

System 800 may utilize any suitable number, type, arrangement, and configuration of seismic receivers 804. For example, system 800 may include dozens, hundreds, thousands, or any suitable number of seismic receivers 804. As another example, seismic receivers 804 may have any suitable arrangement, such as random, linear, grid, array, or any other suitable arrangements, and spacing between seismic receivers 804 may be uniform or non-uniform. Furthermore, seismic receivers 804 may be located at any suitable position. For example, seismic receivers 804 may be located on surface 812, above surface 812, or below surface 812. Furthermore, in off-shore embodiments, seismic receivers 804 may also be located at any suitable depth within the water.

Seismic receivers 804 may detect seismic waves during periods when seismic sources 802 are generating seismic signals 806. Such periods may be referred to as periods of active acquisition. During periods of active acquisition, seismic receivers 804 may detect seismic signals. Such recordings may span seconds, hours, days, months, or years. Such detections may be continuous or periodic during this span of time. In some embodiments, signals detected by the same seismic receivers 804 at different calendar times may be used to calculate 4D images that depict apparent changes in the survey area over time. Furthermore, seismic waves detected by seismic receivers 804 may be communicated to seismic computing system 902 for processing, as described further below with respect to FIG. 9.

Seismic signals 806 represent portions of seismic waves generated by seismic source 802 that arrive at seismic receivers 804. Seismic signals 806 may be body waves or surface waves, and seismic signals 806 may reach seismic receivers 804 after travelling various paths. For example, these waves may pass straight to seismic receivers 804, or they may reflect, refract, diffract, or otherwise interact with various subsurface structures. However, for purposes of simplified illustration, only particular reflecting paths are shown. For example, primary wave 806 may propagate from seismic source 802 to reservoir 816, reflect off of reservoir 816, and propagate to receivers 804. Ghost wave 817 may propagate upward from seismic source 802, reflect off of surface 812, propagate to and reflect off of reservoir 816, and propagate to seismic receivers 804. Similarly, ghost wave 827 may propagate from seismic source 802 to reservoir 816, reflect off of reservoir 816, propagate to and reflect off of surface 812, and propagate to seismic receivers 804. Ghost waves 817 and 827 may exhibit time variable properties because those ghost waves propagate through layer 814a. Layer 814a is the layer nearest to surface 812, and the properties of layer 814a may vary over time. For example, properties of layer 814a may vary according to seasonal or other weather conditions. These variations may affect the propagation of seismic waves through layer 814a.

Various embodiments may use any suitable techniques for processing seismic data. For example, in some embodiments, after seismic signals 806 are recorded by seismic receivers 804, the data is collected and organized based on offset distances, such as the distance between a particular seismic source 802 and a particular receiver 804 or the amount of time it takes for signals 806 to reach seismic receivers 804. The amount of time a signal takes to reach a receiver 804 may be referred to as the “travel time.” Data collected during a survey by a particular receiver 804 may be referred to as a “trace” or “input seismic data,” and multiple traces may be gathered, processed, and utilized to generate a model of the subsurface structure. A “gather” refers to any set of seismic data grouped according to a common feature. Other examples of gathers include common conversion point (CCP) gather, a common shot gather (one source 802 or shot received by multiple seismic receivers 804), common receiver gather (multiple sources 802 received by one receiver 804) (CRG), or any other suitable type of gather based on the implementation or goals of the processing. The traces from a gather may be summed (or “stacked”), which may improve the signal-to-noise ratio (SNR) over a “single-fold” stack because summing tends to cancel out incoherent noise. A “fold” indicates the number of traces in a gather. Additional processing techniques may also be applied to the seismic traces to further improve the resulting images. As explained above, noise may be reduced from the seismic traces at any suitable point during the imaging process. For example, de-noising may be performed on pre-stack or post-stack data.

Surveys may be conducted in any suitable area, including on-shore locations, offshore locations, transition zones, or any other suitable area. Such areas may or may not be utilized for production during the survey period. For example, the survey area may include a reservoir 816 that is being actively developed, and surveys may be conducted continuously or periodically during the period of production. Deghosting seismic data in such embodiments provides more accurate information about changes in and around reservoir 816 that are relevant to production. Such information may improve production efficiency, reduce costs, and provide other benefits related to reservoir production.

Surface 812 represents the surface of the earth. Surface 812 may be an air-earth boundary or a water-earth boundary depending on the location of the survey. Layers 814a-c (collectively “layers 814”) represent geological layers. A survey area may have any number, composition, or arrangement of layers 814. Body waves may be refracted, reflected, or otherwise affected when traveling through layers 814, particularly at the interfaces between different layers 814. Surface waves may also be attenuated, dispersed, or otherwise affected by geological structures during propagation. Layers 814 may have various densities, thicknesses, or other characteristics that may affect seismic wave propagation.

Reservoir 816 may be any geological formation targeted for production. For example, reservoir 816 may contain oil, gas, or any other targeted material. In embodiments involving actively producing reservoirs 816, reservoir production may cause changes to reservoir 816 (such as, for example, fluid displacement) or the surrounding layers 814 that may affect the optimal exploration or production strategy. Reducing noise in measured signals as described herein may reduce costs, improve production, and improve safety by providing more accurate depictions of the changes in the survey area over time.

FIG. 9 illustrates a schematic of an exemplary system for reducing noise in input seismic data, in accordance with some embodiments of the present disclosure. System 900 includes sources 802, seismic receivers 804, and seismic computing system 902, which are communicatively coupled via network 910.

Seismic computing system 902 may deghost seismic data generated by a wide variety of seismic sources 902. For example, seismic computing system 902 may operate in conjunction with seismic sources 902 having any structure, configuration, or function described above with respect to FIG. 8. Seismic computing system 902 may include any suitable devices operable to process seismic data recorded by seismic receivers 904. Seismic computing system 902 may be a single device or multiple devices. For example, seismic computing system 902 may be one or more mainframe servers, desktop computers, laptops, cloud computing systems, or any suitable devices. Seismic computing system 902 may be operable to perform the methods of deghosting seismic data using migrated sparse arrays described above with respect to FIGS. 1-8. Seismic computing system 902 may also be operable to coordinate or otherwise control or manage seismic sources 902. Seismic computing system 902 may be communicatively coupled to seismic receivers 904 via network 910 during the recording process, or it may receive the recorded data after the collection is complete. In the illustrated embodiment, computer system 900 includes network interface 912, processor 914, and memory 916.

Network interface 912 represents any suitable device operable to receive information from network 910, transmit information through network 910, perform suitable processing of information, communicate with other devices, or any combination thereof. Network interface 912 may be any port or connection, real or virtual, including any suitable hardware or software (including protocol conversion and data processing capabilities) to communicate through a LAN, WAN, or other communication system that allows seismic computing system 902 to exchange information with network 910, other software seismic computing systems 902, seismic sources 902, seismic receivers 904, or other components of system 900. Seismic computing system 902 may have any suitable number, type, or configuration of network interface 912.

Processor 914 communicatively couples to network interface 912 and memory 916 and controls the operation and administration of seismic computing system 902 by processing information received from network interface 912 and memory 916. Processor 914 includes any hardware or software that operates to control and process information. In some embodiments, processor 914 may be a programmable logic device, a microcontroller, a microprocessor, any suitable processing device, or any suitable combination of the preceding. Seismic computing system 902 may have any suitable number, type, or configuration of processor 914. Processor 914 may execute one or more sets of instructions to implement deghosting of seismic data using migrated sparse arrays, including the steps described above with respect to FIGS. 1-8. Processor 914 may also execute any other suitable programs to facilitate noise reduction of seismic data such as, for example, user interface software to present one or more GUIs to a user.

Memory 916 may store, either permanently or temporarily, data, operational software, or other information for processor 914, other components of seismic computing system 902, or other components of system 900. Memory 916 includes any one or a combination of volatile or nonvolatile local or remote devices suitable for storing information. For example, memory 916 may include random access memory (RAM), read only memory (ROM), flash memory, magnetic storage devices, optical storage devices, network storage devices, cloud storage devices, solid state devices, external storage devices, or any other suitable information storage device or a combination of these devices. Memory 916 may store information in one or more databases, file systems, tree structures, any other suitable storage system, or any combination thereof. Furthermore, different types of information stored in memory 916 may use any of these storage systems. Moreover, any information stored in memory may be encrypted or unencrypted, compressed or uncompressed, and static or editable. Seismic computing system 902 may have any suitable number, type, or configuration of memory 916. Memory 916 may include any suitable information for use in the operation of seismic computing system 902. For example, memory 916 may store computer-executable instructions operable to perform the steps discussed above with respect to FIGS. 1-8 when executed by processor 914. Memory 916 may also store any seismic data or related data such as, for example, input seismic data, reconstructed signals, velocities, amplitudes, signal variations, or any other suitable information.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, “A and B” means “A and B, jointly or severally,” unless expressly indicated otherwise or indicated otherwise by context.

Particular embodiments may be implemented as hardware, software, or a combination of hardware and software. As an example and not by way of limitation, one or more computer systems may execute particular logic or software to perform one or more steps of one or more processes described or illustrated herein. Software implementing particular embodiments may be written in any suitable programming language (which may be procedural or object oriented) or combination of programming languages, where appropriate. In various embodiments, software may be stored in computer-readable storage media. Any suitable type of computer system (such as a single- or multiple-processor computer system) or systems may execute software implementing particular embodiments, where appropriate. A general-purpose computer system may execute software implementing particular embodiments, where appropriate. In certain embodiments, portions of logic may be transmitted and or received by a component during the implementation of one or more functions.

Herein, reference to a computer-readable storage medium encompasses one or more non-transitory, tangible, computer-readable storage medium possessing structures. As an example and not by way of limitation, a computer-readable storage medium may include a semiconductor-based or other integrated circuit (IC) (such as, for example, an FPGA or an application-specific IC (ASIC)), a hard disk, an HDD, a hybrid hard drive (HHD), an optical disc, an optical disc drive (ODD), a magneto-optical disc, a magneto-medium, a solid-state drive (SSD), a RAM-drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, non-volatile, or a combination of volatile and non-volatile, where appropriate.

This disclosure encompasses all changes, substitutions, variations, alterations, and modifications to the example embodiments herein that a person having ordinary skill in the art would comprehend. For example, while the embodiments of FIGS. 1, 2, 8 and 9 illustrate particular configurations of seismic sources and seismic receivers, any suitable number, type, and configuration may be used. As another example, any suitable method of calculating reconstructed signals may be used in certain embodiments. As yet another example, while this disclosure describes certain data processing operations that may be performed using the components of system 900, any suitable data processing operations may be performed where appropriate. Furthermore, certain embodiments may alternate between or combine one or more data processing operations described herein.

Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for deghosting seismic data comprising:
obtaining input seismic data, the input seismic data including:
a first set of seismic data recorded by a first set of seismic receivers located at a first depth;
a second set of seismic data recorded by a second set of seismic receivers located at a second depth;
migrating the first set of seismic data to an image grid;
migrating the second set of seismic data to the image grid;
calculating a ghost wave based on the first and second sets of migrated seismic data; and
deghosting the first set of migrated seismic data by removing the ghost wave.

2. The method of claim 1, further comprising calculating a variation of the deghosted first set of migrated seismic data.

3. The method of claim 1, wherein calculating the ghost wave further comprises:
identifying a first arrival time of a primary wave in the first set of migrated seismic data;
identifying a second arrival time of a ghost wave in the first set of migrated seismic data;
calculating a first offset by subtracting the first arrival time from the second arrival time;
identifying a third arrival time of a primary wave in the second set of migrated seismic data;
identifying a fourth arrival time of a ghost wave in the second set of migrated seismic data;
calculating a second offset by subtracting the third arrival time from the fourth arrival time; and
calculating a propagation delay by subtracting the first offset from the second offset.

4. The method of claim 1, wherein calculating the ghost wave further comprises:
estimating a seismic wave velocity at the first and second depths;
calculating a depth offset by subtracting the first depth from the second depth; and
calculating a propagation delay by dividing the depth offset by the estimated seismic wave velocity.

5. The method of claim 3, wherein calculating the ghost wave further comprises:
time shifting the second set of migrated seismic data by the propagation delay; and
summing the time shifted second set of migrated seismic data and the first set of migrated seismic data.

6. The method of claim 3, wherein calculating the ghost wave further comprises:
mathematically calculating the ghost wave according to the formula: G₁(f)[S₁(f)−τ·S₂(f)]/[1−τ²], wherein:
f corresponds with a selected frequency;
G₁(f) corresponds with the ghost wave at f;
S₁(f) corresponds with the first set of seismic data at f;
S₂(f) corresponds with the second set of seismic data at f; and
τ corresponds to a phase term corresponding to the arrival time difference dt between the two levels of sources or seismic receivers separated by the depth difference Δz,

7. The method of claim 1, wherein removing the ghost wave comprises solving an inverse problem using the first set of seismic data and an estimated time-variable wavelet.

8. A seismic data system for deghosting seismic data, comprising:
a processor;
a memory communicatively coupled to the processor;
a first set of seismic receivers located at a first depth;
a second set of seismic receivers located at a second depth, the second depth below the first depth;
a seismic source;
instructions stored in the memory that, when executed by the processor, cause the processor to:
obtain input seismic data, the input seismic data including:
a first set of seismic data recorded by the first set of seismic receivers;
a second set of seismic data recorded by the second set of seismic receivers; and
migrate the first set of seismic data to an image grid;
migrate the second set of seismic data to the image grid;
calculate a ghost wave based on the first and second sets of migrated seismic data; and
deghost the first set of migrated seismic data by removing the ghost wave.

9. The system of claim 8, the instructions further causing the processor to calculate a variation of the deghosted first set of migrated seismic data.

10. The system of claim 8, wherein calculating a ghost wave comprises:
identifying a first arrival time of a primary wave in the first set of migrated seismic data;
identifying a second arrival time of a ghost wave in the first set of migrated seismic data;
calculating a first offset by subtracting the first arrival time from the second arrival time;
identifying a third arrival time of a primary wave in the second set of migrated seismic data;
identifying a fourth arrival time of a ghost wave in the second set of migrated seismic data;
calculating a second offset by subtracting the third arrival time from the fourth arrival time; and
calculating a propagation delay by subtracting the first offset from the second offset.

11. The system of claim 10, wherein calculating the ghost wave comprises:
estimating a seismic wave velocity at the first and second depths;
calculating a depth offset by subtracting the first depth from the second depth; and
calculating a propagation delay by dividing the depth offset by the estimated seismic wave velocity.

12. The system of claim 8, wherein calculating the ghost wave further comprises:
time shifting the second set of migrated seismic data by the propagation delay; and
summing the time shifted second set of migrated seismic data and the first set of migrated seismic data.

13. The system of claim 8, wherein calculating the ghost wave further comprises:
mathematically calculating the ghost wave according to the formula: G₁(f)[S₁(f)−τ·S₂(f)]/[1−τ²], wherein:
f corresponds with a selected frequency;
G₁(f) corresponds with the ghost wave at f;
S₁(f) corresponds with the first set of seismic data at f;
S₂(f) corresponds with the second set of seismic data at f; and
τ corresponds to a phase term corresponding to the arrival time difference dt between the two levels of sources or seismic receivers separated by the depth difference Δz,

14. The system of claim 8, wherein removing the ghost wave comprises solving an inverse problem using the first set of seismic data and an estimated time-variable wavelet.

15. A non-transitory computer-readable medium, comprising instructions that, when executed by a processor, cause the processor to:
obtain input seismic data, the input seismic data including:
a first set of seismic data recorded by a first array of seismic receivers located at a first depth;
a second set of seismic data recorded by a second set of seismic receivers located at a second depth, the second depth below the first depth; and
migrate the first set of seismic data to an image grid;
migrate the second set of seismic data to the image grid;
calculate a ghost wave based on the first and second sets of migrated seismic data; and
deghost the first set of migrated seismic data by removing the ghost wave.

16. The non-transitory computer-readable medium of claim 15, the instructions further causing the processor to calculate a variation of the deghosted first set of migrated seismic data.

17. The non-transitory computer-readable medium of claim 15, wherein calculating the ghost wave comprises:
identifying a first arrival time of a primary wave in the first set of migrated seismic data;
identifying a second arrival time of a ghost wave in the first set of migrated seismic data;
calculating a first offset by subtracting the first arrival time from the second arrival time;
identifying a third arrival time of a primary wave in the second set of migrated seismic data;
identifying a fourth arrival time of a ghost wave in the second set of migrated seismic data;
calculating a second offset by subtracting the third arrival time from the fourth arrival time; and
calculating a propagation delay by subtracting the first offset from the second offset.

18. The non-transitory computer-readable medium of claim 15, wherein calculating the ghost wave further comprises:
time shifting the second set of migrated seismic data by the propagation delay; and
summing the time shifted second set of migrated seismic data and the first set of migrated seismic data.

19. The non-transitory computer-readable medium of claim 15, wherein calculating the ghost wave further comprises:
mathematically calculating the ghost wave according to the formula: G₁(f)[S₁(f)−τ·S₂(f)]/[1−τ²], wherein:
f corresponds with a selected frequency;
G₁(f) corresponds with the ghost wave at f;
S₁(f) corresponds with the first set of seismic data at f;
S₂(f) corresponds with the second set of seismic data at f; and
τ corresponds to a phase term corresponding to the arrival time difference dt between the two levels of sources or seismic receivers separated by the depth difference Δz,

20. The method of claim 15 wherein removing the ghost wave comprises solving an inverse problem using the first set of seismic data and an estimated time-variable wavelet.
